(19) United States
(12) Patent Application Publication
(10) Pub. No.: US 2009/0043640 A1
(43) Pub. Date: Feb. 12, 2009

(54) INFORMATION PORTAL WEBSITE FOR WIDELY-DISTRIBUTED COMPLEX COMMODITIES

(76) Inventor: Neil Sutton, Watertown, CT (US)

Correspondence Address: DICKSTEIN SHAPIRO LLP, 1177 AVENUE OF THE AMERICAS (6TH AVENUE), NEW YORK, NY, 10036-2714, US

(21) Appl. No.: 12/187,181

(22) Filed: Aug. 6, 2008

Related U.S. Application Data
(60) Provisional application No. 60/954,532, filed on Aug. 7, 2007.

(51) Int. Cl. G06Q 30/00; G06Q 50/00

(52) U.S. Cl. 705/10; 705/1; 705/28; 705/27

(57) ABSTRACT

The system and methods of the present application comprise one or more computers that perform a search for complex products for purchase. Information and computer software stored and executed on a general purpose computer provide a member of a Web site with the ability to obtain recommendations for purchase of complex products based on the member's profile and the characteristics of available complex products. The system and methods also determine the characteristics that potentially matching complex products would possess to match the member's preferences.

### CROSS REFERENCE TO RELATED APPLICATIONS

This application claims the benefit of U.S. Provisional Patent Application No. 60/954,532, filed Aug. 14, 2007, entitled, “Information Portal Website for Widely-Distributed Complex Commodities,” which is incorporated by reference herein for all purposes.

### FIELD OF THE INVENTION

The present invention relates generally to the field of product purchasing recommendations and more particularly, a system and process for gathering expert information about widely-distributed, complex commodities, and latent consumer preferences, and providing product recommendations based on this information.

### BACKGROUND OF THE INVENTION

A number of search engines are currently available on the Internet, accessible via the World Wide Web, to help people find goods or services. In addition, there are a number of Internet vending sites, such as Amazon.com™, that provide users with the ability to browse and purchase products online. Many of these sites provide a browser with the ability to search for and select particular books, for example, by supplying keywords that are present in the title or description of the book. Other Web sites that do not supply such search capability, but make their Web pages available, can be periodically crawled by standard search engines, and those search engines can be used for the same type of keyword searches of such Web sites.

Some general vending Web sites allow the customer to specify a particular category of products such as books, for example, that are appropriate to a particular age group, are in a particular price range, have a particular genre, or come from a particular publisher. For example, a customer can select and purchase a book by providing a credit card number for payment, and an address where the book should be shipped. Other Web sites provide the consuming browser with the ability to search based on certain product related criteria, availability or price. For example, one can search Amazon.com™ for books by Category/subcategory (e.g., law/intellectual property/patents) and come up with a list of books relating to that subject matter. Other book criteria include Format (printed or audio), Binding (paperback/hardback), Promotion (4-for-3 or bargain), Condition (new/used/collectible), or Shipping Options.

Similarly, certain Web-based movie-rental vendors may solicit rental of movies for consumers to let, based on their previous selections. Such recommendations are made based generally on the genre preferred by the consumer. For example, a renter who has rented romantic comedies several times in the recent past might be encouraged to rent a relatively newer, popular movie of this particular genre. A movie-renting consumer generally possesses the training to determine whether the proposed movie may fit their taste, perhaps by reviewing the plot described, or by recognizing the actors whose works they have enjoyed.

But certain products are of sufficient complexity that the average consumer cannot determine the product's characteristics. A complex product is a product possessing characteristics that can be evaluated both subjectively as well as objectively, and the objective criteria are not well known. Experts that evaluate complex products tend to agree on the characteristics of complex products, and can even determine superiority though the criteria they evaluate, even though these criteria are considered to be subjective.

In addition, complex products come from a vast plurality of product sources. Such wide variety makes it humanly impossible to maintain familiarity with the characteristics of the entire marketplace of products, especially since average consumers are not trained to properly analyze the complex products that they might purchase.

For example, consider a complex product such as wine. The characteristics of wine are not as easy to determine as a movie. Wines do not provide a plot or listing of actors upon which the consumer may rely. The flavor profile of a wine is not as obvious with a wine as a film genre. In fact, many wine consumers are not even familiar with the criteria that experts use to evaluate wines. In addition, many wine consumers may not have developed their taste buds enough to discern differences in the characteristics between products and understand or describe those differences. However, most consumers know whether they liked a wine that they consumed, but they might not know why they liked it. What is needed is the assistance of a critical review by one or more experts, who can discern and describe the finer points and detailed characteristics that comprise the flavor profile of a particular vintage.

When a complex product becomes a widely-distributed commodity, the marketplace largely becomes a hit-or-miss proposition. Prior art Web sites vending non-complex products do not need to ensure that products retrieved during key word or product recommendation searches gain the benefit of experts' knowledge concerning the products sought. Additionally, untrained consumers do not or cannot effectively evaluate available complex products on the market that would be suitable for their own consumption, i.e., based on their previous selections and preferences. The plethora of criteria in certain widely-distributed complex products, such as wines, for example, often creates confusion in the potential consumer's selection process, and an especially daunting task for those with limited knowledge of the product. The sheer variety renders selection of such complex products difficult, because comparisons between one variety and another may be difficult, or even inappropriate. Therefore, there is a need for a system that can provide recommendations for complex products that are tailored to individual consumers.

### BRIEF SUMMARY OF THE INVENTION

The system and methods of the present application comprise one or more computers that perform a search for complex products for purchase. Information and computer software stored and executed on a general purpose computer provide a member of a Web site with the ability to obtain recommendations for purchase of complex products based on the member's profile and the characteristics of available complex products. The system and methods also determine the characteristics that potentially matching complex products would possess to match the member's preferences.

In an exemplary embodiment, a consumer indicates that they like particular wines, and these wines might uniformly exhibit the same notes, such as plum or currant notes, although the consumer might not realize this. The consumer only recognized that he liked the wine. The correlation of notes, however, may provide an indication of similar wines that the consumer might like.

In one aspect, the present invention is directed to a method of providing recommendations to consumers of complex products, comprising: accumulating an inventory of available complex products from a plurality of sellers; collecting information concerning a plurality of characteristics of the available complex products; receiving ratings from a consumer concerning one or more complex products; determining preferred characteristics of complex products from the rated complex products; finding a set of matching complex products based on the preferred characteristics; and recommending a plurality of complex products to the consumer from the set based on product availability of the complex products in the set.

In another aspect of the present invention, complex product availability comprises geographic proximity to the consumer.

In another aspect of the present invention, the method further comprises displaying recommended complex products and expert ratings.

In another aspect of the present invention, the method further comprises receiving information on an associated product to the complex product, and wherein the recommending is based on compatibility with the associated product.

In another aspect of the present invention, the complex product is wine and the associated product is food.

In another aspect of the present invention, the method further comprises selecting products from the set of matching complex products and wherein the recommending step is further based on products selected.

In another aspect of the present invention, the complex product is wine, and the finding step further comprises matching color, dryness, and body style.

In another aspect of the present invention, the finding step further comprises matching fruit flavor characteristics.

In another aspect of the present invention, the set further comprises complex products matching collated objective characteristics of the rated complex products.

In another aspect, the present invention is directed to a product recommendation system, comprising: a computer having a memory and a processor; and a computer-readable medium for generating software code, which, when said code is loaded into the memory and run by the processor, causes the processor to perform the steps of: accumulating an inventory of available complex products from a plurality of sellers; collecting information concerning a plurality of characteristics of the available complex products; receiving ratings from a consumer concerning one or more complex products; determining preferred characteristics of complex products from the rated complex products; finding a set of matching complex products based on the preferred characteristics; and recommending a plurality of complex products to the consumer from the set based on product availability of the complex products in the set.

In another aspect of the present invention, the code further causes the processor to determine geographic proximity of a seller to the consumer.

In another aspect of the present invention, the code further causes the processor to display recommended complex products.

In another aspect of the present invention, the code further causes the processor to receive information on an associated product to the complex product, and wherein the recommending is based on compatibility with the associated product.

In another aspect of the present invention, the code further causes the processor to select products from the set of matching complex products and wherein the recommending step is further based on products selected.

In another aspect of the present invention, finding further comprises matching fruit flavor characteristics.

In another aspect of the present invention, the code further causes the processor to determine the set as further comprising complex products matching collated objective characteristics of the rated complex products.

In another aspect, the present invention is directed to a method of providing wine recommendations to consumers, comprising: accumulating an inventory of available wines from a plurality of sellers; collecting expert information concerning a plurality of characteristics of the available wines; receiving ratings from a consumer concerning one or more wines; determining preferred characteristics from the rated wines; finding a set of matching wines based on the preferred characteristics; and recommending one or more wines to the consumer from the set based on available inventory.

### BRIEF DESCRIPTION OF THE DRAWINGS

FIG. 1 is a block diagram that illustrates an computer architecture of a preferred embodiment of the present invention;

FIG. 2 is a block diagram that illustrates the interrelationship between data stored on a server computer;

FIG. 3 is a diagram illustrating a database schema of some of the tables in relational database;

FIG. 4 is a flow chart that illustrates a preferred method for users accessing a complex-product Web site;

FIG. 5 is a flow chart that illustrates a preferred method for members accessing a complex-product Web site;

FIG. 6 is a screen diagram illustrating an exemplary categorical search;

FIG. 7 is a screen diagram illustrating an exemplary lists defined by a member;

FIG. 8 is a flow chart that illustrates a preferred method for performing a complex-product search; and

FIG. 9 illustrates examples of computer-readable media.

### DETAILED DESCRIPTION OF THE INVENTION

The present invention comprises a system and methods for recommending particular products that are complex, i.e., products produced by many different sources and having many different characteristics. The system comprises one or more computers that interact with a user in order to determine the user's preferences, available inventory, and authoritative determinations of product characteristics, and matches products having characteristics that would be suitable for the user's consumption.

The present invention may be described herein in terms of functional block components, code listings, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as C, C++, C#, Java, COBOL, assembler, perl, Visual Basic, python, CGI, PHP or the like, with the various algorithms being implemented with any combination of data structures, objects, processes, routines or other programming elements. The object code created for the computers can preferably be executed by any general purpose computer such as a personal computer having an appropriate operating system such as Windows™ or Mac™ and an appropriate browser such as Internet Explorer,™ Netscape™, Firefox™, Opera™ or Safari.™

Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical or virtual couplings between the various elements. It should be noted that many alternative or additional functional relationships or physical or virtual connections may be present in a practical electronic data communications system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described below with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified functions or steps, or suitable combinations of special purpose hardware and computer instructions.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The scope of the invention should be determined by the appended claims and their legal equivalents, rather than by the examples given herein. For example, the steps recited in any method claims may be executed in any order and are not limited to the order presented in the claims. Moreover, no element is essential to the practice of the invention unless specifically described herein as “critical” or “essential.”

System Architecture

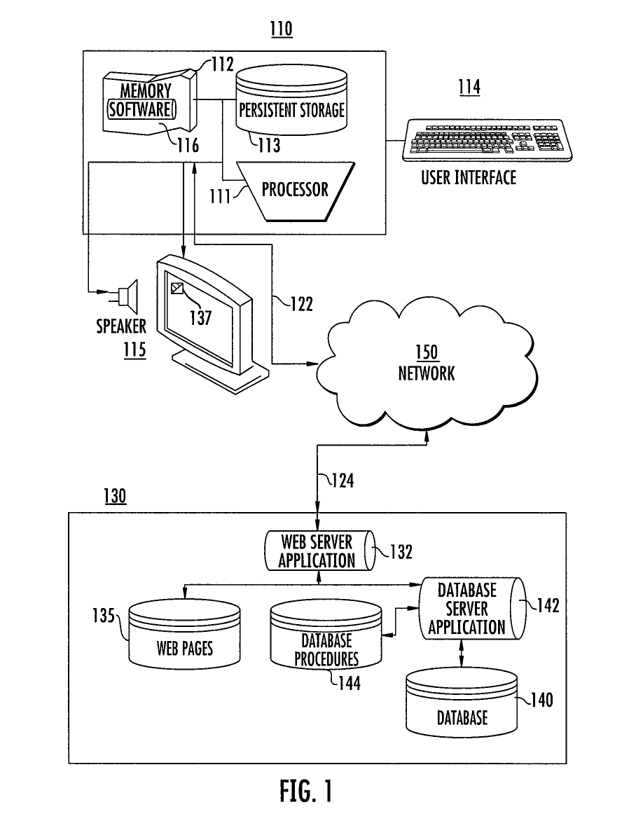

FIG. 1 is a block diagram that illustrates a computer architecture of a preferred embodiment of the present invention. In a preferred embodiment, the system and method of the present invention are directed to a computer in communication with a server through the Internet. Referring to FIG. 1, one or more client computers 110 and a server computer 130 are coupled over communication links 122, 124, respectively to network 150. Network 150 may comprise, for example, the Internet, a wide area network (WAN), or a local area network (LAN). Together, browser software that executes on a client computer 110 and software on server computer 130 forms a client/server software system.

Client computer 110 comprises a processor 111, memory 112, user interface 114 and a display 115. Memory 112 may also include persistent storage 113. In a preferred embodiment, software on client computer 110 comprises a Web browser 116, such as Internet Explorer™, Netscape™, Firefox™, Opera™, Safari™ or other Web browser pre-loaded into memory 112 of client computer 110 or readily-available for download from the Internet into memory 112. Such browsers retrieve Web pages 135 from a Web server 130 in response to inputs on user interface 114. Web pages 135 are loaded into memory 112 and then rendered on display 115.

User interface 114 comprises controls that are preferably graphically represented buttons 137, with symbols commonly found in many Web pages to permit entry of information or selection of actions. User interface 114 may be a keyboard, mouse or other pointing device, or other information or control input device that affects the operation of client computer 110, as is well known in the art. User interface 114 may also comprise a microphone that provides the user with a means to convey digitized audio information.

Display 115 comprises a CRT (cathode ray tube) or LCD (liquid crystal display), or other visual display device as is commonly known in the art. Display 115 may further comprise speakers that receive digitized audio signals and emit audio output audible to the user. As is well known in the art, speakers may also be in a headset that comprises a microphone.

Software on server computer 130 preferably comprises a Web server application 132. Web server application 132 listens for TCP/IP (transport control protocol/Internet protocol) connections on a well-known port and receives standard HTTP (hyper-text transfer protocol) requests on that port that identifies particular URL (universal resource locator) that indicates Web pages 135 and other information requested, typically by Web browser 116 on client computer 110. Preferably, Web server application 132 comprises Apache and a collection of software modules that generate HTML (hyper-text markup language) Web pages 135. In alternate embodiments, the functions performed by server computer 130 are split among several server computers, for example, having components of Web server application 132 executed on computers different from database server application 142 (described below). Furthermore, these servers may be geographically separated and, for example, coupled through network 150.

In addition, server computer 130 includes a database 140 that includes information related to products. A database server application 142 is coupled to database 140 and provides an interface to the information stored in database 140 to other application software modules that execute on server computer 130. In a preferred embodiment, database 140 is a relational database, which includes a number of interrelated tables. Database server application 142 is preferably an SQL (structured query language) server that accepts queries according to an SQL syntax and provides responses to those queries. Database server application 142 can perform stored database procedures 144 comprising complex queries stored in SQL syntax on server computer 130. Such queries may involve multiple fetching processes from more than one table in the tables that comprise database 140. Stored database procedures 144 are stored in a file system on server computer 130.

Although FIG. 1 illustrates only one server computer 130 and one client computer 110 in communication through network 150, it should be understood that different numbers of computers may be utilized. In one example, the claimed method and system may comprise a single, stand-alone computer, in which case the network would comprise the internal data communication bus of such computer. In another example, the network 150 may include a plurality of network computers and tens or hundreds of computers, all of which may be interconnected via the network 150. In a preferred embodiment, a plurality of client computers 110 are able to simultaneously connect to the server 130. The communication links 122, 124 may be provided as a dedicated hardwired link or a wireless link. Although the communication links 122, 124 are shown as a single data link, they may comprise multiple data links.

The networked computers, client computer 110 and server computer 130, may be provided in many different geographic locations, including a liquor store kiosk, library, home, cell phone, PDA, different areas of the same city, or they may be located in different states or even countries. Network 150 may include a plurality of network computers or server computers (not shown), each of which may be operatively interconnected. Where the network 150 comprises the Internet, data communication may take place over communication links via an Internet communication protocol (UDP/IP or TCP/IP). Where the network 150 comprises a wireless network, data communication may take place over communication links via a wireless data protocol such as CDMA2000 or W-CDMA. Similarly, where the network communications comprise data, voice and video, communication may take place via an Internet communication protocol or a wireless protocol.

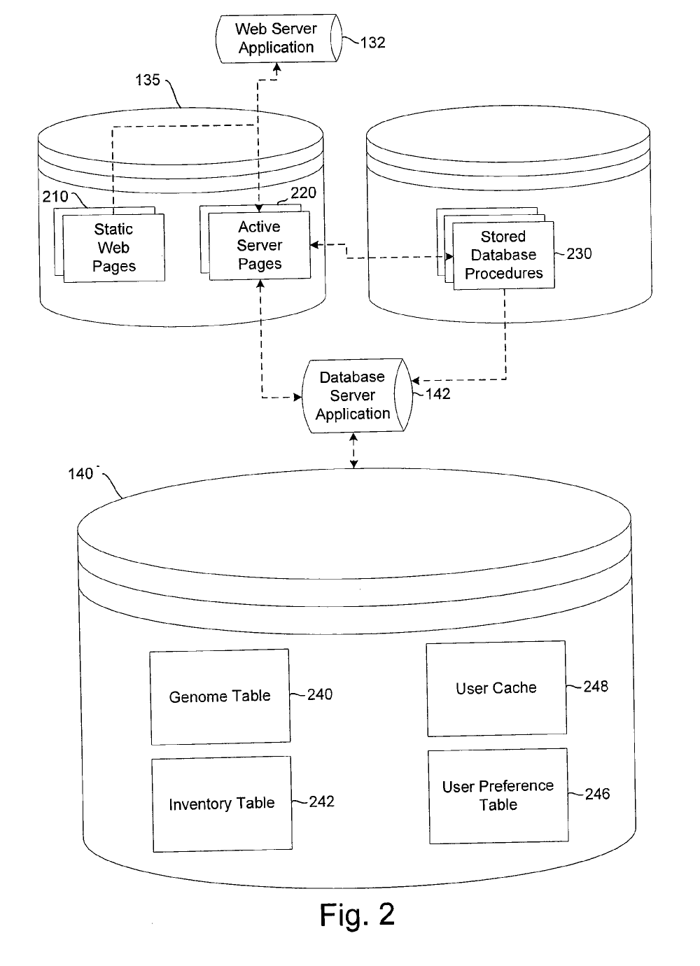

FIG. 2 is a block diagram that illustrates the interrelationship between data stored on a server computer. Referring to FIG. 2, Web pages 135 comprise at least two types of pages. One type are static Web pages 210, that are HTML format pages passed on by Web server application 132 direct to a requesting Web browser without modification. The other type are dynamic or active server pages 220. An active server page 220 includes a procedure specification that, when requested by a Web browser, is executed under the control of Web server application 132 rather than being directly passed to the Web browser. Execution of the procedure specified by an active server page 220 produces HTML formatted information that is passed by Web server application 132 to a Web browser. In a preferred embodiment, active server pages 220 can be generated by a Visual Basic language procedure, CGI scripts, or a procedure written in some other programming or scripting language such as java, perl, python or PHP, that are executed under the control of Web server application 132.

Active server pages 220 can include references to services provide by database server application 142. For instance, a Visual Basic procedure in active server page 220 accesses database server application 142 through an API (application program interface) for the database server application. During execution of the stored procedure, Web server application 132 can access data stored in database 140. Active server pages 220 can also include references to stored database procedures 230. Each stored database procedure 230 includes one or more SQL statements. Web server application 132 invokes a stored database procedure 230 during execution of an active server page 220. Database server application 142 controls the execution of stored database procedure 230 to provide data to Web server application 132. Together, static Web pages 210, active server pages 220, and stored database procedures 230 provide the information to generate Web pages through which a user interacts with the system.

Database 140 includes a number of separate tables. As illustrated in FIG. 2, database 140 comprises a genome table 240, an inventory table 242, a user preference table 246, and a user cache 248. All tables in database 140 are dynamic in that they can be modified, for example, as new information is added or as existing information is modified or refined. As well known in the art, these tables may be indexed to provide associations between them on certain key fields. Also, additional tables may be included that provide other information needed to serve up dynamic web pages presented to the user. Other tables may include certain static or semi-static information such as user or vendor information, which may comprise account names, passwords, given names, business names, addresses, etc.

Genome table 240 stores both objective and expert-supplied subjective information about complex products. Inventory table 242 stores information concerning identification of complex products, locations where particular complex products are available, price and quantities of available complex products. User preference table 246 comprises identifiers for complex products that the user has purchased and preferred in the past. Additionally, user preference table 246 may comprise user ratings of complex products.

User cache 248 is used to store intermediate results while the system interacts with a user during a session. User cache 248 is used to avoid computing results again during a current session and improves the user's experience during the session. Information in user cache 248 has a limited lifetime. For example, data in user cache 248 is periodically removed if it has not been accessed for a predetermined amount of time.

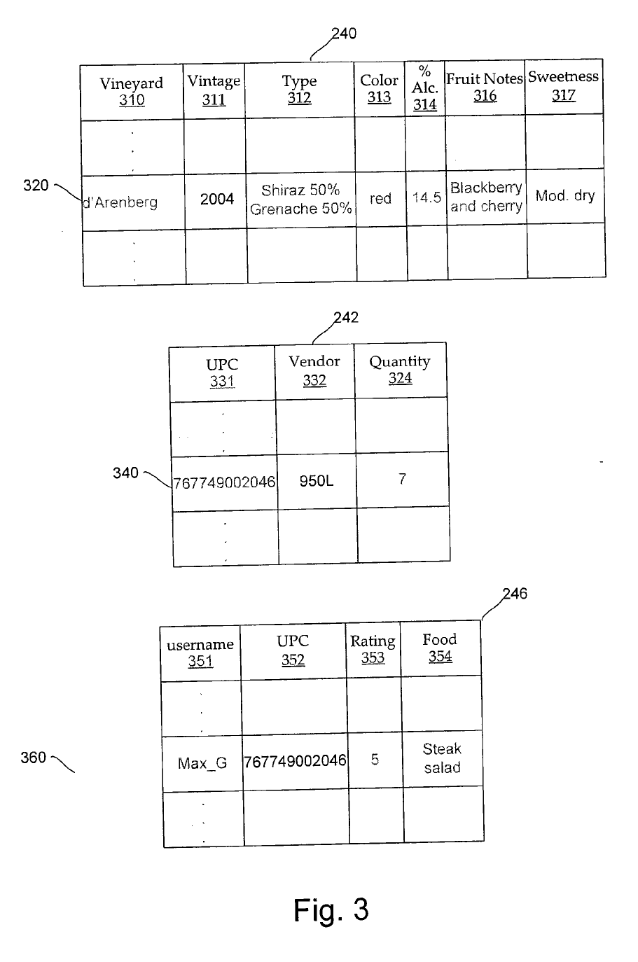

FIG. 3 is a diagram illustrating a database schema of some of the tables in relational database 140 in a preferred embodiment of the present invention. Referring to FIG. 3, database 140 includes a genome table 240 that comprises information regarding wine, an inventory table 242 that relates complex products to vendors, and a user preference table 246 that relates users to past experiences with particular complex products.

Genome table 240 comprises fields for both objective and subjective information about the complex product. FIG. 3 illustrates a preferred embodiment for the complex product wine. As shown in FIG. 3, genome table comprises the following objective fields: vineyard 310, vintage 311 type 312, color 313, % alcohol 314. Many other objective fields maybe included in the genome table that are not illustrated in FIG. 3, such as Uniform Product Code (UPC), grapes, region, appellation, cellarability and bottle size, etc. Certain fields may only contain limited values. Values for type 312 include bubbly, still, dessert or fortified. Values for color 313 include red, white or rose.

Values for grapes include, but are not limited to: Aligote, Chardonnay, Chenin Blanc, Colombard, Folle Blanche, Gewurztraminer, Gruner Veltliner, Malvasia, Marsanne, Melon de Bourgogne, Muller-Thurgau, Muscadelle, Muscat, Palomino, Pedro Ximinez, Pinot Blanc, Pinot Gris, Riesling, Rousanne, Sauvignon Blanc, Scheurebe, Semillon, Sylvaner, Trebbiano, Ugni Blanc, Verdicchio, Viognier, Barbera, Brunello, Cabernet Franc, Cabernet Sauvignon, Carignane, Carmencre, Cinsault, Dolcetto, Durif, Gamay, Grenache, Grignolino, Malbec, Merlot, Montepulciano, Mourvedre, Nebbiolo, Petit Sirah, Petit Verdot, Pinotage, Pinot Meunier, Pinot Noir, Sangiovese, Shiraz/Syrah, Tempranillo, Tinta Barroca, Tinta Cao, Touriga Francesa, Touriga Nacional, Tinta Roriz, or Zinfandel.

Values for region include, but are not limited to: California, Washington, Oregon, Australia, New Zealand, Bordeaux, Rhone, France (other regions), Italy, Spain, Portugal, Israel, Germany, Greece, Europe, South America, South Africa or Canada. Values for Appellation include, but are not limited to: Champagne, Chile, Coonawarra, Austria, Barossa Valley, Burgundy, Napa Valley, Canada, Beaujolais, Carneros, Russian River, Alsace, Argentina, Clare Valley, Columbia Valley, Melaren Vale, Tuscany, Yarra Valley, Greece, Chablis, Hungary, Victoria, Margaret River, Israel, Rheingau, Sonoma County, Provence, Languedoc-Roussillon, Santa Maria Valley, Loire, Mosel-Saar-Ruwer, Piedmont, Rioja, Yakima Valley, Tentino-Alto Adige, Ribera Del Duero, Germany, Priorat, Navarra, Santa Cruz Mountains, Central Coast, North Coast, Sierra Foothills, California, Portugal, Fruili-Venezia Giulia, Rias Baixas, Veneto, Southern Italy, Sardinia, Walla Walla Valley, Washington, South Australia, South Africa, Willamette Valley, France, Sicily, Italy, Hermitage, Chateauneuf-Du-Pape, Gigondas, Vacqueyras, Cotes Du Rhone, Rhone, Hunter Valley, Australia, Martinborough, Marlborough, Central Otago, New Zealand, St. Estephe, Pauillac, St-Julien, Medoc, Pessac-Leognan, St-Emilon, Pomerol, Bordeaux, Rueda, Jumilla, Spain.

As also shown in FIG. 3, genome table comprises subjective fields too, such as fruit notes 316 and sweetness 317. Subjective fields included in the genome table depend upon the complex product. Subjective fields not illustrated in FIG. 3 for wine include fruitiness, oak, scent, body style, smoothness, butteriness, or ratings, etc.

Values for fruitiness include, but are not limited to: high, moderate and low. Values for fruit notes 316 include, but are not limited to varieties of tropical fruits, temperate zone fruits and cool zone fruits. Values for sweetness 317 include, but are not limited to: very dry, dry, moderately dry, balanced, moderately sweet, sweet and very sweet. Values for oak include, but are not limited to: high, moderate and low. Values for scent include, but are not limited to: earthy, spicy, crisp, floral, citrus, oaky and tropical. Values for body style include, but are not limited to: full, full medium, medium, light medium and light. Values for smoothness include, but are not limited to: harsh, flabby and balanced. Values for butteriness include, but are not limited to: high, medium, low and none.

Illustrated in FIG. 3 is an exemplary row 320 for genome table 240 populated with data. Data in exemplary row 320 is for a wine from a vineyard “d'Arenberg.” This red wine has a vintage year of 2004. The type of wine is 50% Shiraz and 50% Grenache. It is 14.5% alcohol by volume, and exhibits blackberry and cherry fruit notes. It is a moderately dry red wine.

Inventory table 242, illustrated in FIG. 3, comprises fields UPC 321, Vendor 322, and Quantity 324. UPC 321 represents an identifier for a particular complex product. Vendor 322 is a unique identifier for a seller of the complex product. Quantity 324 is the number of units that the vendor has in stock.

An exemplary row 340 for inventory table 242 is illustrated in FIG. 3. Data in exemplary row 340 is for a UPC identifier 767749002046 (which is the UPC for d'Arenberg, discussed above). The vendor possessing this complex product has an identifier code of 950L. The vendor has 7 units available.

User preference table 246, illustrated in FIG. 3, comprises the fields username 351, UPC 352, rating 353 and food 354. Username 351 comprises an identifier for the browser of the Web site. UPC 352 is a product code of the complex product being rated. Rating 354 is a rating that the user supplies for the product. Food 354 is an identifier for the type of food the user ate with the complex product. As well known to those with skill in the art, other types of associations, depending on the complex product, could be made.

An exemplary row 360 for user preference table 246 is illustrated in FIG. 3. Data in exemplary row 360 is for a user having a username Max_G. He rated a UPC having an identifier 767749002046 a “5” on a rating scale. He had this wine with steak.

System Operation

The following discussion describes the methods performed by the inventive system. To provide context, the operation of an exemplary, preferred embodiment of web server application 132 and database server application 142 are described. The description is based on those actions that the computers will perform when the applications are generated, loaded and run. Although the following discussion describes the operation of a Web site for vending a particular complex product, wine, it should be understood that the disclosure is not so limited, and is applicable to all complex products.

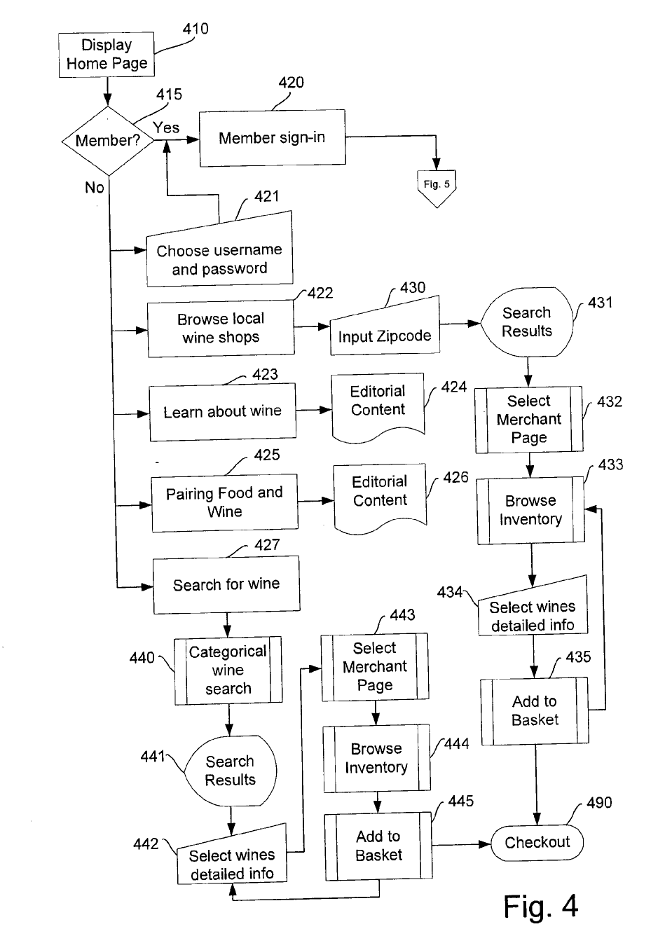

FIG. 4 is a flow chart that illustrates a preferred method for users accessing a complex-product Web site. As shown in FIG. 4, at step 410, a user that enters a URL for the Web site in their browser will cause the browser to make a request to the Web server. In return, the Web server will return a home page, which is displayed by the user's browser.

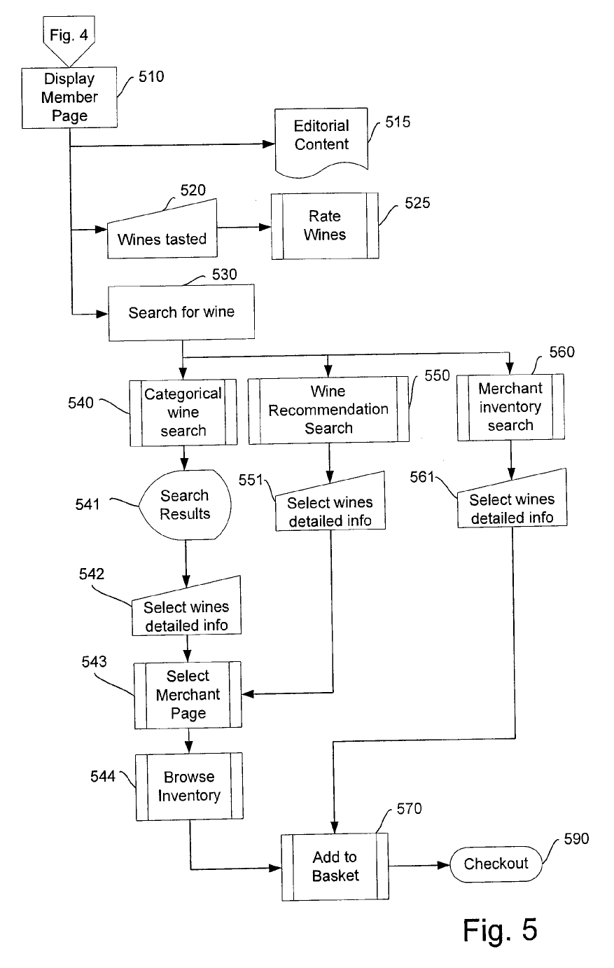

In step 415, a determination is made as to whether the user is a registered member of the Web site. Such determination may be made, for example, by presenting the user with fields for entry of a username and a password. In step 420, the system will preferably check the entered information against that stored in the database to authenticate the user as a member. If this check is successful, processing will proceed to steps illustrated on FIG. 5.

If the user is not a member, the user may join the Web site, as illustrated in step 421. The user supplies a username and password for storage in the Web site database. This information will be used to authenticate the user at login.

Non-member users may choose several other functions provided by the Web site. In step 422, users may browse for local wine shops in their area. In step 430, for example, the user enters a zipcode or some other geolocating information, as well-known in the art. In step 431, a listing of wire merchants are provided to the user. In step 432, the user may select particular merchants from which the user would like to shop. In step 433, the user may browse the selected merchants' inventory of available wines. In step 434, the user selects wines that the user would like to purchase. The system provides the user with detailed information concerning the wine, including, for example, price and quantities available, for each merchant selected, along with detailed reviews concerning the selected wines. If the user wishes to purchase the selected wine, in step 435, the user places the wine in their virtual basket. Operation passes back to step 433, if the user wishes to continue to browse inventory. Alternatively, if the user is done shopping, operation passes to step 490 checkout, where the user provides payment and shipping information.

Other informational functions are provided to non-member users. For example, in step 423, users may choose to learn about wines. In step 424, editorial content is provided to the user based on topic selected by the user for their perusal. As yet another example, certain important topics may be selected, as shown in step 425 for example, which provides information on pairing food with wines. In step 426, editorial content is provided to the user on this important topic. In addition, tutorials or quizzes may be provided to further engage the user and promote the user's comprehension of the subject matter. Also, rewards may be provided for successful completion of topics.

In step 427, the user may search for particular wines. In step 440, the user provides information needed to perform categorical searches for wine. These searches may be based on type, region, or other characteristics of the complex product searched for. In step 441, search results are provided to the user. In step 442, the user selects wines that the user would like to purchase from those returned by the categorical search. The system provides the user with detailed information concerning the wine, including, for example, price and quantities available, for merchants having available quantity, along with detailed reviews concerning the selected wines. If the user wishes to purchase the selected wine, in step 443, the user may select particular merchants from which the user would like to purchase. In step 444, the user may browse the selected merchants' inventory of wines selected from the categorical search. In step 445, the user places the wine in their virtual basket. Operation passes back to step 442, if the user wishes to continue to select wines. Alternatively, if the user is done shopping, operation passes to step 490 checkout, where the user provides payment and shipping information.

FIG. 5 is a flow chart that illustrates a preferred method for members accessing a complex-product Web site. In addition to the functional aspects provided to all users, members are provided additional functions illustrated on FIG. 5, such as maintaining lists of wines, getting personalized recommendations for wines, and buying wines from online vendors. As shown in FIG. 5, in step 510, after logging in the member's browser is provided and displays the member's home page. In step 515, the member may access particular editorial content provided to members about wines.

In step 520, the member may identify particular wines that they have tasted. In step 525, the member may rate the wines that they identify. These ratings will be used to determine product recommendations by the search engine, as described further below.

In step 530, the member searches for wines. In addition to the searches described above for all users, the member may also perform a wine recommendation search 550.

In more detail, in step 540, the member selects wines by performing a categorical search. These searches may be based on type, region, or other characteristics of the complex product searched for.

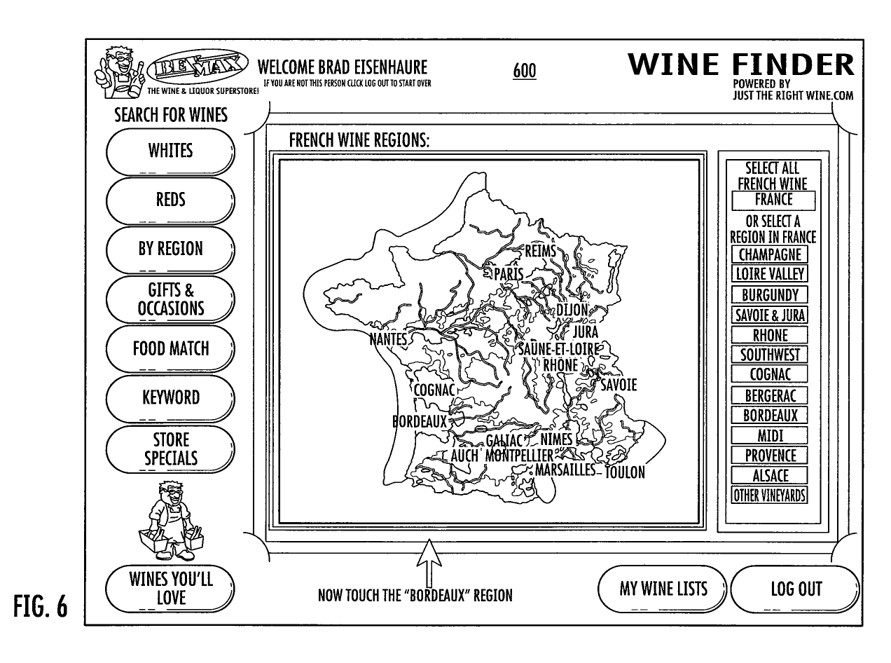

FIG. 6 is a screen diagram illustrating an exemplary categorical search 600. As illustrated in FIG. 6, the member may search for wines based on the region where the vineyard is located. The member can drill down to specific regions, and then find all the wines in that particular region.

Returning to FIG. 5, in step 541, search results are provided to the member. These results may lead to yet another round of category specification, to narrow the number of varieties of complex products found. In step 542, the member selects wines that she would like to purchase from those returned by the categorical search. The system provides the member with detailed information concerning the wine, including, for example, price and quantities available, for merchants having available quantity, along with detailed reviews concerning the selected wines.

If the member wishes to purchase the selected wine, in step 543, the member may select particular merchants from which the wine may be purchased. These merchants may include traditional brick and mortar liquor stores that may ship or deliver the product, or permit the member to pick up and carry out. In step 544, the member may browse the selected merchants' inventory of wines selected from the categorical search. In step 570, the member places the wine in their virtual basket. Operation passes back to various steps in the process (not illustrated) if the member wishes to continue to select wines. Alternatively, if the member is done shopping, operation passes to step 590 checkout, where the member authorizes payment and shipping based on information kept in the members profile. Alternatively, if the member is purchasing from a brick and mortar vendor, the member may simply reserve the product and will make payment at the vendor when the product is picked up.

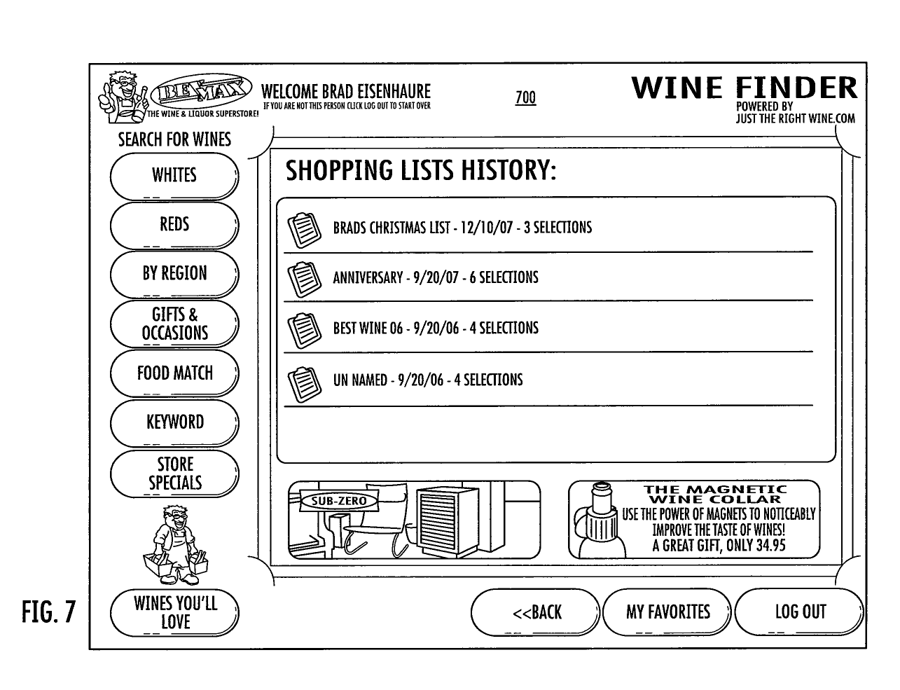

In addition, members may maintain a variety of shopping lists of wines that they may purchase. FIG. 7 is a screen diagram illustrating an exemplary lists 700 defined by a member. As shown in FIG. 7, the member has access to a history of shopping lists, that the member uses to shop for wines.

Returning to FIG. 5, in step 550, the member searches for wines based on product recommended by the search engine, as described in more detail below. In step 551, the member selects wines that she would like to purchase from those returned by the product recommendation search. The system provides the member with detailed information concerning the wine, including, for example, price and quantities available, for merchants having available quantity, along with detailed reviews concerning the selected wines. Operation then passes to step 543, described above.

In step 560, the member may specify and select particular merchants from which the member would like to purchase. The member browses the selected merchants' inventory of wines. In step 561, the member selects wines that she would like to purchase from those returned by the product recommendation search. The system provides the member with detailed information concerning the wine, including, for example, price and quantities available, for merchants having available quantity, along with detailed reviews concerning the selected wines. Operation then passes to step 570, described above, where the member places the selected wine in their virtual basket.

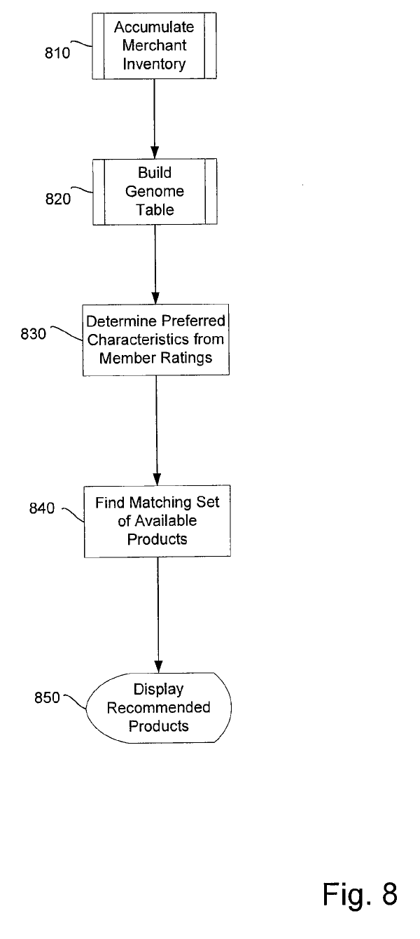

FIG. 8 is a flow chart that illustrates a preferred method for performing a complex-product search. As shown in FIG. 8, in step 810, merchant inventory is collected for complex products, on a continuous basis. The collected information is added to the various database tables described above.

In step 820, the genome table is built. Information describing the characteristics of complex products is added to this table. Like step 810, step 820 is a continuous process—information is added or updated as it becomes available.

In step 830, complex products rated by the members are analyzed to determine the characteristics that comprise the preferences of the member. In such analysis, a profile for the member is developed for one or more groups of complex products. The profile is determined from those complex products that the member identified, as described in steps 520 and 525 above. In a preferred embodiment, a flavor profile is developed for the member, profiling one or more groups of wines. Characteristics of products are weighted more heavily for products rated more highly by the member.

In step 840, the system determines a set of complex products that match the member profile generated in step 830, preferably for the one or more groups of complex products that the member profile covers. Naturally, those products that are currently available for purchase are included in the set. In a preferred embodiment, the matching algorithm comprises a multi-level comparison of complex product characteristics with the member profile.

In a further preferred embodiment, the member's flavor profile is used to identify wines that the member would prefer. Wines tend to cluster into families of flavor, so the best matching would require using (at least) four levels to allow for worthwhile recommendations.

The first level would be by fruit flavors, matching, as closely as possible, into warm, temperate, and cool wine zones. Wines made from the grapes in each zone have overtones of fruits native to the zone (with a certain amount of overlap). So, warm climate wines often suggest pineapple, mango, melon, etc.; temperate zone wines suggest blackberry, cherry, currant, etc. in red wines, and citrus flavors in white; and cool weather wines go toward apple and pear in the white, with reds going closer to blueberry and other berries, but often being less fruit-forward.

The second level is simply oak vs. no oak. In reds, oak means tannin, and a rounder, fuller, robust flavor; in whites, it means a full, buttery quality that has become so familiar that people now just call it “oaky”. Wines aged without oak are not less complex, but have different sets of flavor profiles. They are sometimes perceived as brighter.

The third level is stylistic—e.g., European vs. American. European style (French in particular) is not as boldly fruity as American, where the fruit can be right on top. Some of the flavor notes in the fourth level come much more to the fore in European wines, which are often called more “subtle” than wines from the U.S., Australia, South America, etc. As with all the criteria, there is both overlap and cross-fertilization, with European vintners developing properties abroad and exporting their styles and techniques, and U.S. critics' huge influence changing winemaking worldwide.

The fourth level would include all the remaining characteristics for wines—which are almost limitless. A sample of some common descriptors: mushrooms, leather, floral, cedar, licorice, chocolate, vanilla, barnyard, mineral, various herbs and spices, vegetables, and smoke.

In a preferred embodiment, the set of complex products may be further refined by determining compatibility with an associated product. In an exemplary embodiment, the compatibility of wine with food may be used as a criterion to refine the set of matching complex products.

In step 850, a set of complex products found to match, or most nearly match, the member's profile, which are available for purchase, are recommended to the member. In a preferred embodiment, availability may be determined from the geographic proximity of the merchant to the member. In an alternative embodiment, such recommendations may be presented to the member after enough information has been gathered to perform the process described above. For example, after rating wines, wine recommendations may be presented immediately to the member on the member's home page, which is presented in step 510, described above.

Software on Media

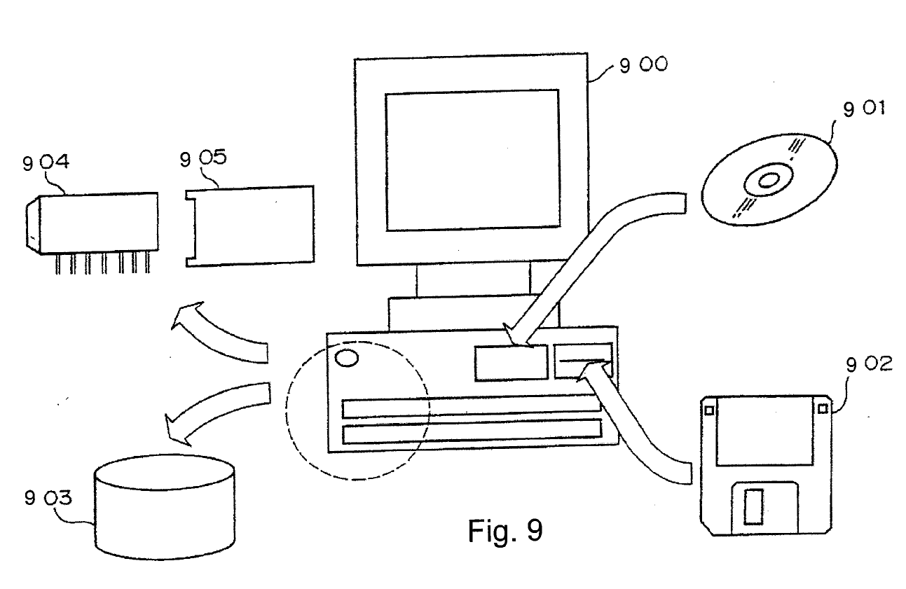

In the specification, the term “media” means any computer-readable medium that can record data therein. FIG. 9 illustrates examples of recordable computer-readable media.

The term “media” includes, for instance, a disk shaped media for 901 such as CD-ROM (compact disc-read only memory), magneto optical disc or MO, digital video disc-read only memory or DVD-ROM, digital video disc-random access memory or DVD-RAM, a floppy disc 902, a memory chip 904 such as random access memory or RAM, read only memory or ROM, erasable programmable read only memory or E-PROM, electrical erasable programmable read only memory or EE-PROM, a rewriteable card-type read only memory 905 such as a smart card, a magnetic tape, a hard disc 903, and any other suitable means for storing a program therein.

A recording media storing a program for accomplishing the above mentioned apparatus maybe accomplished by programming functions of the above mentioned apparatuses with a programming language readable by a computer 900 or processor, and recording the program on a media such as mentioned above.

A server equipped with a hard disk drive may be employed as a recording media. It is also possible to accomplish the present invention by storing the above mentioned computer program on such a hard disk in a server and reading the computer program by other computers through a network.

As a computer 900, any suitable device for performing computations in accordance with a computer program may be used. Examples of such devices include a personal computer, a laptop computer, a microprocessor, a programmable logic device, or an application specific integrated circuit.

Having thus described at least illustrative embodiments of the invention, various modifications and improvements will readily occur to those skilled in the art and are intended to be within the scope of the invention. Accordingly, the foregoing description is by way of example only and is not intended as limiting. The invention is limited only as defined in the following claims and the equivalents thereto.

What is claimed is:

1. A method of providing recommendations to consumers of complex products, comprising:
accumulating an inventory of available complex products from a plurality of sellers;
collecting information concerning a plurality of characteristics of the available complex products;
receiving ratings from a consumer concerning one or more complex products;
determining preferred characteristics of complex products from the rated complex products;
finding a set of matching complex products based on the preferred characteristics; and
recommending a plurality of complex products to the consumer from the set based on product availability of the complex products in the set.

2. The method of claim 1, wherein complex product availability comprises geographic proximity to the consumer.

3. The method of claim 1, further comprising displaying recommended complex products and expert ratings.

4. The method of claim 1, further comprising receiving information on an associated product to the complex product, and wherein the recommending is based on compatibility with the associated product.

5. The method of claim 4, wherein the complex product is wine and the associated product is food.

6. The method of claim 1, further comprising selecting products from the set of matching complex products and wherein the recommending step is further based on products selected.

7. The method of claim 1, wherein the complex product is wine, and the finding step further comprises matching color, dryness, and body style.

8. The method of claim 7, wherein the finding step further comprises matching fruit flavor characteristics.

9. The method of claim 1, wherein the set further comprises complex products matching collated objective characteristics of the rated complex products.

10. A product recommendation system, comprising:
a computer having a memory and a processor; and
a computer-readable medium for generating software code, which, when said code is loaded into the memory and run by the processor, causes the processor to perform the steps of:
accumulating an inventory of available complex products from a plurality of sellers;
collecting information concerning a plurality of characteristics of the available complex products;
receiving ratings from a consumer concerning one or more complex products;
determining preferred characteristics of complex products from the rated complex products;
finding a set of matching complex products based on the preferred characteristics; and
recommending a plurality of complex products to the consumer from the set based on product availability of the complex products in the set.

11. The system of claim 10, wherein the code further causes the processor to determine geographic proximity of a seller to the consumer.

12. The system of claim 10, wherein the code further causes the processor to display recommended complex products.

13. The system of claim 10, wherein the code further causes the processor to receive information on an associated product to the complex product, and wherein the recommending is based on compatibility with the associated product.

14. The system of claim 10, wherein the code further causes the processor to select products from the set of matching complex products and wherein the recommending step is further based on products selected.

15. The system of claim 10, wherein the complex product is wine, and wherein the finding step further comprises matching color, dryness, and body style.

16. The system of claim 10, wherein finding further comprises matching fruit flavor characteristics.

17. The system of claim 10, wherein the code further causes the processor to determine the set as further comprising complex products matching collated objective characteristics of the rated complex products.

18. A method of providing wine recommendations to consumers, comprising:
accumulating an inventory of available wines from a plurality of sellers;
collecting expert information concerning a plurality of characteristics of the available wines;
receiving ratings from a consumer concerning one or more wines;
determining preferred characteristics from the rated wines;
finding a set of matching wines based on the preferred characteristics; and
recommending one or more wines to the consumer from the set based on available inventory.
